(19) United States
(12) Patent Application Publication
(10) Pub. No.: US 2019/0251505 A1
(43) Pub. Date: Aug. 15, 2019

(54) System and Method for Managing Deliveries of Goods

(71) Applicants: John Simms, Mclean, VA (US); Noel Simms, Jackson, MS (US); John Simms, JR., Arlington, VA (US)

(72) Inventors: John Simms, Mclean, VA (US); Noel Simms, Jackson, MS (US); John Simms, JR., Arlington, VA (US)

(21) Appl. No.: 15/897,389

(22) Filed: Feb. 15, 2018

(51) Int. Cl. G06Q 10/08; G06Q 10/10; G06Q 30/06

(52) U.S. Cl. CPC G06Q 10/0836; G06Q 30/0633; G06Q 10/1097

(57) ABSTRACT

A system, method and platform for managing the delivery of goods ordered by a customer from a provider thereof to a Smart Locked Storage Container (SLSC), associated with a corresponding customer comprising: a customer server for ordering and managing the goods to be delivered to the SLSC; a delivery server for managing deliveries of the goods to the SLSC; a communicator for enabling communications between the provider, the delivery server and/or the customer server; a controller for controlling the communications; and a signaler for transmitting a signal to the SLSC allowing access by the delivery agent, the customer, and/or an agent of the customer.

### BACKGROUND OF INVENTION

The recent upsurge in e-commerce whereby a consumer accesses a website over the Internet to purchase goods for delivery to the home, office or other site has created a need for secure systems/methods for scheduling and tracking deliveries of the purchased items, as well as for providing a safe and secure site for receipt of the goods when they are delivered to an unoccupied site. The convenience of being able to avoid making trips to a brick and mortar store or outlet to purchase goods, and having the goods delivered to home, office or other site is off-set by the problems surrounding the secure delivery of the goods to the purchaser. If the purchaser is not available on-site to receive the goods, delivery must either be re-scheduled or the goods must be left unsecured at the site, thereby being subject to theft or damage.

U.S. Pat. No. 6,933,832 describes a system and method which enables the delivery, and safe and secure receipt of purchased items or other goods, at an unattended site.

The patented method and system enables the delivery of at least one purchased or ordered item to a Smart Locked Storage Container, associated with a corresponding customer, the method comprising, following the purchase or order of the at least one item, determining the availability of the SLSC to receive the delivery at one or more times, identifying a time interval during which the delivery can be made, and sending to the SLSC an access signal allowing a delivery agent access to the SLSC only during the time interval for delivery thereto of the at least one item.

Copending patent application Ser. No. 14/544,035, filed Feb. 2, 2015, describes an improvement in the patented system wherein the delivery agent is a drone aircraft.

Home delivery of goods comprises a multi-hundred billion dollar market. The home food delivery market alone is estimated to be over $200 billion. However, theft is common. Nearly 11 million U.S. homeowners have had at least one package stolen within the past year.

Existing Band-Aid type solutions to the theft problem have turned out to be easily side-stepped by determined thieves. Recent “solutions”, such as, installing smart lock+camera combinations accomplish secure delivery of the ordered/purchased goods only by allowing entry into the interior of the building to which delivery is being made, have very low customer acceptance as being too invasive.

On-demand delivery systems requiring tight time windows for delivery only when the delivery site is occupied have proven to be logistically difficult and expensive. Delivery solutions which are exclusive and brand-specific do not reflect customer buying habits and result in bad customer experiences. Present day “Lockers” still require the consumer to travel to a pick-up location, thereby defeating the purpose of the proposed solution. In addition, no solution presently on the market answers the need for insulation of perishable goods without the considerable expense of packing materials and the concomitant waste.

### SUMMARY OF THE INVENTION

The present invention relates to still further improvements in the patented system. More specifically, the present invention satisfies the need for secure delivery and provides a better customer experience at less cost.

One aspect of the disclosure relates to a system for managing the delivery of goods ordered by a customer from a provider thereof to at least one smart SLSC (SLSC), each SLSC associated with the customer comprising:
a customer server for ordering and managing the goods to be delivered to the at least one SLSC;
a delivery server for managing deliveries of the goods to the at least one SLSC by a delivery agent;
a smart communicator for enabling communications between the provider of goods, the delivery server, a signaler and/or the customer server;
a controller for controlling the communications; and
a signaler communicatively connected to the SLSC for transmitting a signal to the SLSC allowing access thereinto by the delivery agent, the customer, and/or an agent of the customer.

Another aspect of the disclosure concerns a method for method for managing the delivery of goods ordered by a customer from a provider thereof to at least one smart SLSC (SLSC), each SLSC associated with the customer comprising utilizing:
a customer server to order and manage the goods to be delivered to the at least one SLSC;
a delivery server to manage deliveries of the ordered goods to the at least one SLSC by a delivery agent;
a smart communicator to enable communications between the provider of goods, the delivery server, a signaler and/or the customer server;
a controller to control the communications; and
a signaler communicatively connected to the SLSC to transmit a signal to the SLSC allowing access thereinto by the delivery agent, the customer, and/or an agent of the customer.

Furthermore, the present disclosure may be embodied by a non-transitory recording medium which is readable by a device such as a processor, computer, a machine, or the like and on which a program for utilizing the above-described system to carry out the above-described method is recorded. In this case, a recording medium that is readable by a computer or the like refers to a recording medium which stores information such as data and programs by an electric action, a magnetic action, an optical action, a mechanical action, or a chemical action and which can be read by a computer or the like.

### DESCRIPTION OF THE DRAWINGS

FIG. 1 is an elevational view of a SLSC.

FIG. 2 is a flow sheet depicting the steps of the method of the invention overlaid on the main components or participants in the method.

FIG. 3 is an elevational view of the front of a storage container.

FIG. 4 is an elevational view of the rear of a storage container.

FIG. 5 is a cut-away view of the interior of a storage container.

FIG. 6 is a block diagram of a system utilizing a computer as the controller between the electronic key to the SLSC and the communications network.

FIG. 7 is a simplified flow chart of the delivery method.

FIG. 8 is a block diagram illustrating an embodiment of the system according to the invention.

FIG. 9 is a flow diagram illustrating embodiments of the method according to the invention

FIG. 10 is a block diagram illustrating an embodiment of the controller in the system according to the invention.

FIG. 11 is a flow diagram illustrating the disadvantages of the sytems of the prior art.

FIG. 12 is a flow diagram illustrating embodiments of the method according to the invention which ameliorate the disadvantages illustrated in FIG. 12

FIG. 13 is a flow diagram illustrating embodiments of the method according to the invention.

FIG. 14 is a flow diagram illustrating a revenue model of embodiments of the method according to the invention.

FIG. 15 is a block diagram illustrating an embodiment of the system of the invention.

### DETAILED DESCRIPTION OF THE INVENTION

The present invention is predicated on the discovery of a system, method and program for managing the delivery to and the receipt of goods or other items in a SLSC, including but not limited to ordering or purchasing goods, scheduling and tracking deliveries, receiving deliveries of the goods, making and processing payment, inventorying items scheduled for delivery and items delivered and making information about deliveries available to the deliverer and/or customer.

The system, method and program of the invention, referred to herein in their entirety as HomeValet, comprise a delivery platform for the secure, unattended receipt of goods delivered by any provider thereof and delivery agent to a SLSC located at any suitable venue, such as, for example, the home or office.

Goods delivered to most homes or other venues today are left unattended at the front door vulnerable to elements and theft. As consumers come to rely on e-commerce to supply groceries and everyday consumables, in addition to clothing and specialty items, and as the frequency and cumulative value of deliveries increases, delivery problems due to damage, theft and inconvenience will become a major concern of online consumer and retailers and an impediment to growth.

HomeValet integrates a platform for consumers and delivery agents, a network and a SLSC at a venue for the unattended, local delivery of goods, groceries, prepared foods, prescription drugs, electronics, alcoholic beverages, clothing, gifts and more. Deliveries will be made to the SLSC at any time without consumers inconvenienced by inconvenient delivery time windows and retailers burdened with the costs of compressed delivery schedules, protective delivery packaging, and package re-delivery, damage and returns.

HomeValet may become an integral complement to every smart home and as necessary as a home security system and at about the same monthly cost, and less than a high speed Internet connection or cable tv subscription. Depending on the consumer's choice of loyalty program, HomeValet may be substantially free to the consumer.

Retailers will experience savings because of less spoilage, damage and theft, less expensive packaging, streamlined delivery with no multiple attempts and lower cost delivery cost of returns. A better customer experience and an expanding customer audience in home delivery will be the greatest gain for customer and retailer.

HomeValet is retailer, delivery service and SLSC agnostic. Access will be provided to e-commerce retailers, brick and mortar retailers [Jet, Amazon, Ebay, Peapod, CVS, Macys, Wayfair, Grubhub, Williams Sonoma, and the like], and national, regional and local delivery carriers [FedEx, UPS, USPS, Doordash, lnstacart, Uber, Postmates, Amazonlogistics, and the like]. Typical of manufacturers of SLSC would include Kenmore, Maytag, Viking, Samsung, LG, Whirlpool, Coleman, Yeti, and the like.

Those provided access will receive a mobile app (or APIs), scheduling software, and permissions on request to access SLSCs to make deliveries. Retailers with a local or regional presence, by employing local carriers with access to the HomeValet system, will be able to compete with existing systems for ordering and delivering goods, without the high cost of developing their own delivery capability. One option for HomeValet is to offer a crowd sourced, Uber-like, system as an alternative. A copending U.S. patent application describes a real-time auction of scheduled deliveries to participating crowd sourced drivers.

HomeValet will provide connectivity and functionality to appliance manufacturers who may build, install, and market their branded version of SLSC. These may comprise appliances in a wide variety of sizes, facades, and capabilities, some integral to the home and some standalone. Manufacturers will be able to innovate and differentiate design to address physical requirements and market segments as is presently accomplished with refrigerators, stoves, or any major home appliance.

Having access to HomeValet's scheduling and delivery system and SLSC appliance provide a competitive advantage for retailers and delivery couriers. HomeValet will enable appliance manufacturers and retailers to provide new products and an enhanced income stream, such as, for example, income on every package delivered, on the licensing of connectivity to appliance manufacturers, on retailer and delivery agent subscriptions to integrate with the HomeValet system, and, in some cases, the rental or purchase of SLSCs to homes and offices.

The present invention is predicated on the unexpected discovery that methods and systems for the delivery of purchased or ordered items to a SLSC can be vastly improved by managing the delivery utilizing the method, system and computer readable non-transitory recording medium of the present invention.

The system and method of the invention are predicated on the availability of at least one Smart Locked Storage Container (SLSC) which is accessible by means of an identifier which unlocks an entry door to the interior of the SLSC.

It will be understood by those skilled in the art that an “identifier” includes a physical device, such as a key, electronic key, smart card, magnetic card, or similar device carried or transported by a delivery agent; a biometric property such as fingerprint, voice recognition, retinal scan of a delivery agent; wireless communication options such as any duplex, half-duplex, or full-duplex communication method including but not limited to: Near Field Communications (NFC), WiFi, Bluetooth, Radio, RFID, Mesh Networking Protocols (i.e. FabFi, G.hn, etc.), Ethernet, Telephone, Fiber Optic, Optical, Barcode, OR Code, or any combination of methods, or any other element which operates to unlock the SLSC upon being sensed and identified by the latter.

According to the improved system and method of the invention, identification may be supplied by any convenient means, including the delivery agent itself. A typical location for the SLSC is near or affixed to the exterior of a home or office. The SLSC is capable of receiving and storing goods for delivery or pickup with a level of security preventing unauthorized entry or theft and with protection against pests and unfavorable weather conditions. The SLSC may be equipped with multiple storage areas, some of which may be cooled or heated. The container may be free-standing, secured to a fixed location or affixed to a structure. It will be understood by those skilled in the art that the SLSC may be pre-assigned to the customer receiving the delivered goods or may be assigned thereto at a later time, such as, for example, the time delivery is scheduled

The SLSC is preferably in electronic communication with a controller; i.e., a computer or computer network by any of a variety of means, including, but not limited to a telephonic signal, television cable, computer network cable, radio signal or the like.

The SLSC receives and transmits data to the controller via a “scheduler” which is capable of organizing and recording a schedule of deliveries and pickups utilizing the SLSC and transmitting instructions to the SLSC allowing it to identify an identifier authorized to access the SLSC in accordance with a schedule. The SLSC is preferably identifiable by the controller with which it is communicating via the smart communicator by identification number, name or location. Each SLSC is also preferably associated with a particular customer's account records, it being understood by those skilled in the art that the above referred to association may be created at any time; e.g., prior to or after any ordering/purchasing of goods, upon scheduling delivery, or immediately prior to or after delivery of the goods has been commenced.

Still another embodiment of the invention comprises a method and system of scheduling and tracking deliveries, of receiving deliveries utilizing a specialized device, of making and processing payment, of inventorying items scheduled for delivery and items delivered and of making information about deliveries available through a variety of means. Users of the method and system may be entities desiring to make deliveries and/or to receive deliveries. Users of the method and system may schedule delivery, track shipment and delivery, make secure delivery to the SLSC, make and confirm payment, inventory items scheduled for delivery and delivered. Users of the method and system may access data regarding the SLSC stored on the computer or computer network and accessed by a variety of means including telephone, radio, computer network or the Internet. The type of data which may be accessed includes, but is not limited to, data concerning the location of the SLSC and alternative delivery locations, the capacity and type of storage of the appliance, the type and availability of storage capacity at the time and date of intended delivery and special instructions or other information pertaining to the delivery appliance and location and method of payment.

One embodiment of the present invention may alternately be described as a system of a plurality of SLSCs, each associated with a corresponding customer, as described above, using a delivery system including a scheduler, the steps including: ordering a first delivery of one or more goods for a first customer associated with a first SLSC of the plurality of SLSCs; following the ordering of the first delivery, determining the availability of the first SLSC to receive the first delivery at one or more times by use of the scheduler: identifying, using the scheduler, a first time interval during which the first delivery can be made; and the delivery system sending to the first SLSC an access signal allowing a first delivery agent which is delivering the delivery to access the first SLSC only during the first time interval. The steps include: ordering a second delivery of one or more goods for the first customer: following the ordering of the second delivery, determining the availability of the first SLSC to receive the second delivery at one or more times by use of the scheduler; identifying, using the scheduler, a second time interval during which the second delivery can be made; and the delivery system sending to the first SLSC an access signal allowing a second delivery agent which is delivering the second delivery to access the first SLSC only during the second time interval.

A delivery can be ordered for one or more goods for a second customer associated with a second SLSC of the plurality of SLSCs. Following the ordering of the last-mentioned delivery, the availability of the second SLSC to receive the last-mentioned delivery at one or more times by use of the schedule is determined. The method identifies, using the scheduler, a second customer time interval during which the last-mentioned delivery can be made; and the delivery system sends to the second SLSC an access signal allowing a delivery agent which is delivering the last-mentioned delivery to access the second SLSC only during the second customer time interval. The first agent opens the first SLSC using an identifier corresponding to the first agent and the second agent opens the first SLSC using an identifier corresponding to the second delivery agent.

Following the ordering, the size of the delivery is determined using the delivery system. Available room within the first SLSC is checked by use of the delivery system. Upon availability as indicated by the checking step, the delivery system reserves sufficient room within the first SLSC to receive the delivery.

Following the first delivery, an account of the first customer is charged for the first delivery to the first SLSC signaling the delivery system of the insertion of the first delivery into the first SLSC. The first SLSC signals the delivery system of the insertion of the first delivery into the first SLSC based on access by the first delivery agent.

Still another embodiment of the invention may alternately be described as a method and system of delivery of ordered items to a plurality of SLSCs by delivery agents using a delivery system, the steps including; ordering a delivery of one or more goods to a first customer; following the ordering, determining the size of the delivery using the delivery system; checking available room within a first SLSC of the plurality of SLSCs, the first SLSC corresponding to the first customer, by use of the delivery system; upon availability, reserving, by operation of the delivery system, sufficient room within the first SLSC to receive the delivery; and delivering the delivery to within the first SLSC. Upon finding that the available room within the first SLSC is insufficient for the size of the delivery, the ordered delivery is divided into at least first and second partial deliveries for separate delivery upon there being available room. The delivery system includes a scheduler and the method further includes the steps of; following the ordering of the delivery, determining the availability of the first SLSC to receive the first and parts at one or more times by use of the scheduler; identifying, using the scheduler, a first time interval during which the first partial delivery can be made and a second time interval during which the second partial delivery can be made; and the delivery system sending to the first SLSC an access signal allowing access to the first SLSC only during the first time interval for delivery of the first partial delivery and during the second time interval for delivery of the second partial delivery. Prior to dividing the ordered delivery, input is received from the customer indicating the customer's preference for a complete delivery or delivery in multiple portions; and the scheduler schedules delivery according to the customer's preference. The method of further includes the step of: charging an account of the first customer for a delivery upon the SLSC signaling the delivery system of the insertion of a delivery into the SLSC.

An additional embodiment of the invention may alternately be described as a method for delivery of ordered items to a plurality of SLSCs by delivery agents using a delivery system, the steps including: ordering a delivery of one or more goods to a customer; delivering the delivery to within one of the SLSCs corresponding to the customer; and automatically sending a DELIVERY MADE signal from the one of the SLSCs signaling the delivery system of the insertion of the delivery into the one of the SLSCs. Upon the delivery system receiving the DELIVERY MADE signal, the delivery system performs one or more steps selected from the group consisting of: charging an account of the customer for the delivery; and automatically initiating a communication to the customer. The delivery system includes a scheduler and further includes the steps of: following the ordering, determining the availability of the one of the SLSCs to receive the delivery at one or more times by use of the scheduler; identifying, using the scheduler, a first time interval during which the delivery can be made; and the delivery system sending to the one of the SLSCs an access signal allowing a first delivery agent which is delivering the delivery to access the one of the SLSCs only during the first time interval. The method further includes the steps of: following the ordering, determining the size of the delivery using the delivery system; and checking available room with the one of the SLSCs by use of the delivery system.

The delivery system, improved by the system and method of the present invention may be described as including: at least one SLSC corresponding to a customer, an order receiver for receiving orders for delivery by a delivery agent of one or more goods for the customer; availability determiner for determining the availability of the SLSC to receive deliveries at one or more times; a scheduler receiving availability information from the availability determiner and operable to identify a time interval during which the delivery can be made and operable to send to a SLSC an access signal allowing a delivery agent that is delivering a delivery to access the SLSC only during the time interval identified by the scheduler, wherein the storage container is equipped with an element for receiving the access signal and landing and loading docks whereby a delivery agent may dock therewith, access the interior of a SLSC and deliver goods thereinto.

The SLSC of the present invention is an appliance equipped as described above with means for a delivery agent to dock therewith and securely deliver goods/items therein, without requiring an agent in attendance to accept delivery and which includes: a storage container; a lock controlling access to the storage container; and a communication link connected to the lock and operable to receive an access signal from a remote location to allow access to the storage container; and wherein the lock is responsive to the communication link receiving the access signal by unlocking upon presentation of an identifier such as described above.

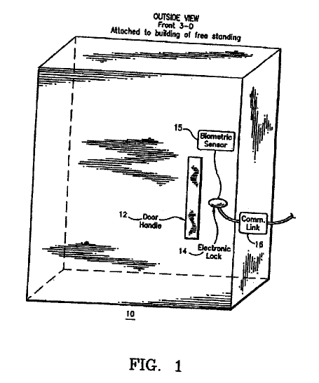

FIG. 1 shows a typical SLSC 10 which is a SLSC with a door handle 12 and an electronic lock 14. The lock 14 may be accessed by a universal key, other physical device or other identifier (including biometric properties as discussed above). The lock 14 is capable of identifying electronically or by other means the key (more generally the identifier) being used for unlocking or opening the SLSC. However, in the preferred design the SLSC 10 is capable of identifying specific keys authorized for entry and/or permitting access by unlocking the door based on instructions communicated to it by a scheduler, remotely located. The scheduler is connected to lock 14 via communications link 16 such as a modern or other interface to the telephone system, the Internet or other communications, and discussed in more detail below. The SLSC is also capable of denying entry to keys not authorized for delivery or not authorized for delivery at that time. The SLSC is preferably capable of recording and/or transmitting a log or other itemized listing of authorized and unauthorized attempt(s) at opening the SLSC and may include among other information the electronic identity of each key, the date and time of the attempt.

The access to SLSC 10 may be explained by an example. A first delivery agent may have an electronic key, such as a smart card or magnetic card, unique to that agent. Alternately, and in lieu of the key or other physical access device, a biometric property (such as fingerprint, voice pattern, retinal pattern) of the delivery agent may be read by an optional biometric sensor 15. A second delivery agent may have an electronic key, such as a smart card or magnetic card, unique to the second company. The first delivery agent may be scheduled for accessing the SLSC 10 during a first time interval such as between 9 AM and 12 noon on a given day, whereas the second delivery agent may be scheduled for accessing the SLSC 10 during a second time interval such as between 1 PM and 4 PM on the same day. Under such circumstances, the lock 14 could only be opened by the first delivery agent's electronic key (not shown) during the first time interval, whereas the lock 14 could only be opened by the second delivery agent's electronic key (not shown) during the second time interval. This assumes that the scheduler switches the lock 14 into an access state in which it is unlockable by an electronic key. Alternately, the scheduler could simply unlock the lock 14 so that a delivery agent could insert items in the SLSC without needing a key.

The time intervals might be much longer then the several hour time intervals above. For example, a time interval of 24 or more hours for a delivery might be used. Further, the first and second time intervals might overlap or even be identical (i.e., two deliveries scheduled for the same time interval).

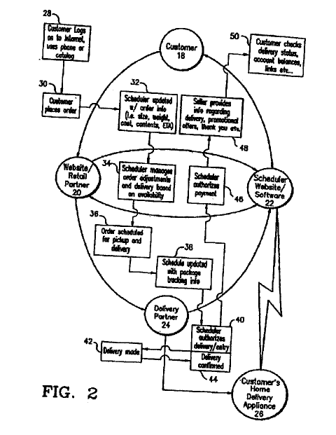

In a typical use of the system and method described above, and with particular reference to FIG. 2, a flow chart is shown overlaid on the main components or participants linked as shown. Discussing first, the main components or participants, the customer 18 is linked to website/retail partner 20 which in turn is linked to a scheduler website software 22 and delivery partner 24. The delivery partner 24 in turn is linked to website/retail partner 20 and also to the customers home delivery attendant 26. The various illustrated links between 18, 20, 22, 24, and 26 would preferably be internet links, but telephone or other links could also be used for some or all of the links. It should be understood that the components 18 through 26 are shown for a particular customer, but in practice there would be a plurality of customers 18 each having an associated home delivery attendant 26. Additionally, the scheduler website/software may interact with a plurality of retail outlets 20 and a plurality of delivery partners 24. For example, there may be a retailer 20 for books, a different retailer 20 for clothing, and numerous other retailers, some competitive with others, all linked to the scheduler 22. The various delivery partners may be specialized on a geographic basis, a delivery basis (i.e., one delivers within one day, another delivers within three days, etc.), and possibly by the type of delivery being made. As will be discussed below, some orders may involve goods requiring special handling such as refrigeration in transit and the delivery partner delivering such goods may need a refrigerator section in a delivery truck.

Turning now to the flow chart part of FIG. 2, the steps are numbered 28 to 50, steps 40 and 44 being within a common box. At box 28, a consumer accesses an e-commerce website over the Internet to purchase goods for home delivery. The consumer identifies himself/herself as an account holder. The retailer/vendor 20 electronically looks up and verifies the account of the consumer against a register or database of accounts made available on-line by the scheduler 22. An account holder is an authorized user of a SLSC 10 (FIG. 1 only) capable of unattended receipt/delivery and of electronically communicating with a specialized computer program (scheduler) which schedules deliveries to the SLSC and reports deliveries to the account holder. The consumer selects items for purchase and delivery and fills an electronic shopping cart.

It will be understood that the invention also contemplates delivery of items ordered by telephone, mail, or in agent at a retail store. The invention also may be used for receiving items that do not involve a commercial transaction. For example, a neighbor could return a borrowed item to the agent owning the SLSC.

As the shopping cart is loaded with goods selected, the estimated total size of the bundle of items as measured by the dimensions of height, width and depth is calculated (with software provided by the scheduler) based on information provided by the seller. Accessing information (provided by the scheduler over a computer network of the Internet) regarding the type and capacity of the SLSC and the estimated remaining capacity of the SLSC at the projected time/date of delivery, the estimated size of the bundle of items is compared against the total volume (including the various dimensions) of space remaining available in the consumer's designated SLSC on the time/date of the proposed date of delivery. Thus, an order that has a length of 5 feet will require 5 feet available within the SLSC 10. If the volume or any dimension of the order exceeds available capacity, the consumer is given the option of splitting the delivery into two or more deliveries, of rescheduling the delivery for another time when capacity is available, or of removing items from the shopping cart.

The retailer or seller notifies the consumer of the final purchase price including shipping and handling. At step 30, the consumer authorizes the purchase and indicates method of payment. The consumer may arrange for payment to seller directly or by debit or credit accounts linked to the consumer's account. The seller finalizes the sale. At block 32, the seller notifies the scheduler 22 (a specialized computer program running on a delivery system computer) of the time/date of the intended delivery and the estimated size of the bundle of items. The scheduler reserves the capacity in the designated SLSC for the scheduled time/date of the delivery. The seller also electronically provides to the scheduler (in format specified by the scheduler) an inventory of items purchased, itemized prices of each item purchased, itemized shipping and handling costs, and any other information permitted by the scheduler including coupon or “cents off” offers and other advertising and promotional information. This information provided by the seller may be made accessible by the scheduler to the consumer by a variety of means and formats, including computer networks, the Internet, electronic mail, telephone or printed matter.

The seller prepares the order for shipment. If any of the items are unavailable at the time that the order is being filled or if other items are added to the shipment for any reason, the estimated size of the bundle of items is adjusted. At step 34, the seller accesses information provided by the scheduler regarding the then available capacity at the time/date of delivery. If space is available, the shipment is scheduled at step 36. If space is unavailable, the shipment is adjusted interactively until available space capacity can be confirmed and reserved. At step 38, the seller electronically provides to the scheduler information to update the order, including any shipping information, routing or tracking numbers, etc., and any additional advertising or promotional information.

Preceding the time/date of each scheduled delivery, the scheduler communicates at step 40 electronic instructions to the SLSC e to permit entry to delivery agent using a key which is identified by the SLSC and matches a key authorized for entry for the scheduled delivery at that date/time (a time interval within an assigned date, or optionally, more than one date). If a key does not match a key authorized for entry at that time/date, entry will be denied. Once entry is gained for an authorized key, that key will be locked out until re-authorized.

When a delivery is made to the SLSC 10 at step 42, the SLSC communicates to the scheduler (by sending a “delivery made” signal) that the delivery was completed at step 44. Debit or credit sales at the point of delivery are processed for payment (costs of the goods and/or delivery applied to an account of the customer) at step 46. The scheduler updates the consumer's account with the time/date of receipt. The vendor selling the goods or service making the delivery may also provide information to the customer's account regarding the time/date of delivery, promotional material and other information specified above, including a “thank you” for the purchase at step 48.

The scheduler updates the consumer's account with various information regarding each purchase and scheduled delivery at step 50. The consumer may access this information through a variety of means including a computer network, an email, the Internet (i.e., checking a web page), a text message to the consumer's pager, or telephone. The consumer may review his/her account through a variety of views including available capacity by time period, committed capacity by time period, chronological list of scheduled deliveries, chronological list of scheduled deliveries by vendor, chronological list of scheduled deliveries by vendor classification (i.e., groceries, dry cleaning, etc.), deliveries made, deliveries missed, inventory of items ordered or delivered (by vendor, vendor classification, time period, etc.), inventory of items ordered but not shipped, calculation of costs (by vendor, vendor type, time period, method of payment, shipping and handling, etc.).

The consumer account holder may request to be notified at various stages of the shipping and delivery process. In addition to information, which is updated to the consumers account and available by means previously specified, the notification may be made via electronic mail, voice or text pager, or telephone, smart phone, Ipad type device or an app.

Although the discussion refers to consumers placing the orders, it will be understood that the agent ordering may also be a business customer ordering supplies for a business.

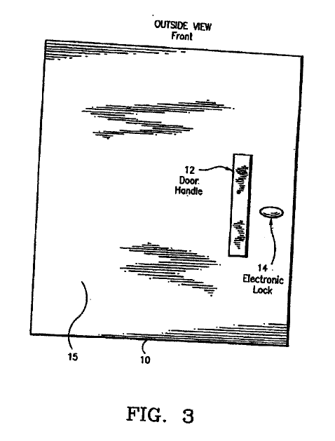

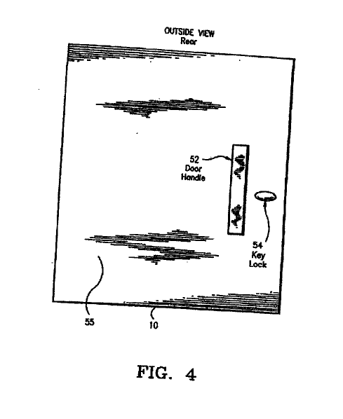

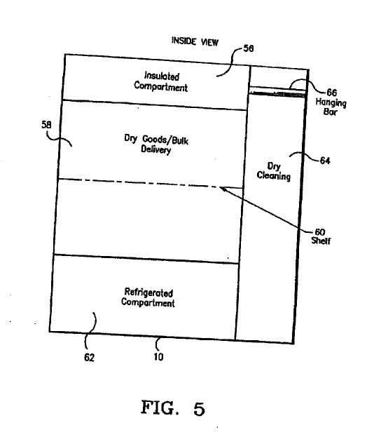

Turning now to FIGS. 2-5, the SLSC 10 details will be discussed. Door handle 12 and electronic lock 14 are on the front of the SLSC 10 and would be used by delivery agents to access the SLSC via a front door 15, Door handle 52 and key lock 54 would be used by the customer (i.e., SLSC owner) to access the rear door 55 of the SLSC 10. In practice, the SLSC 10 may have its front door 15 on the outside of a house (not shown) with the rear door 55 on the inside of the house. In that case, the SLSC would fit in an opening in the wall of the house in similar fashion to some room air conditioners. The inside of the SLSC 10 may include an insulated compartment 56 where items such as hot food (pizza, etc.) may maintain their heat. Dry goods or bulk items may be placed within compartment 58 which is subdivided by a shelf 60. A refrigerated compartment 62 and dry cleaning section 64 with a bar 66 for hanging clothes may also be included. Although not separately shown, a heated compartment and a freezer compartment may also be included.

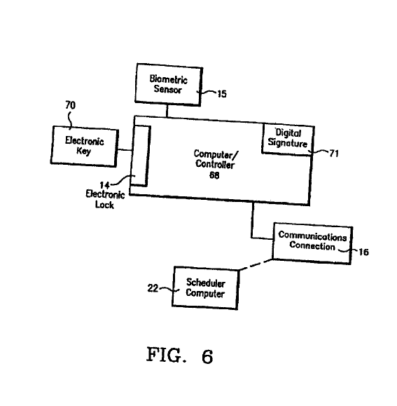

Turning now to FIG. 6, the electronic lock 14 is connected to a computer/controller 68 that is in the SLSC 10. The computer/controller 68, which may operate solenoids or other actuators (not shown) in order to unlock lock 14 or render it accessible (i.e., ready to be unlocked) via electronic key 70, communicates via communication link 16 with the scheduler 22. The link 16 may connect to scheduler 22 via the internet, telephone system, cable, wireless or other technique.

A digital signature 71 may be stored within computer 68 and may be used for acknowledging special deliveries. For example, the delivery of certain pharmaceutical goods may require a signature to acknowledge receipt. Upon the insertion of a pharmaceutical delivery (or any other delivery where signature is desired or required), the computer 68 may send, as part of a DELIVERY MADE signal, an appended digital signature to authenticate the delivery. Alternately, the electronic key 70 may be part of or connected to a small computer carried by the delivery agent and operable to receive the digital signature acknowledging receipt of the delivery. Recent changes in the law in the United States, among other countries, may allow such digital signatures to be used in situations where written signatures were previously used.

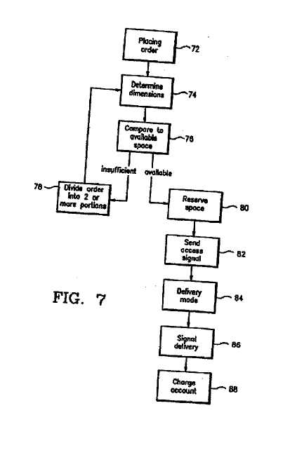

Turning now to FIG. 7, but also considering FIG. 2, a flow chart of some key aspects of the system and method improved by the present invention will be discussed. Except as otherwise noted the steps in FIG. 7 are performed by scheduler 22. The order is placed at step 72 by a customer on his/her computer which communicates it to the scheduler 22. At block 74, the scheduler 22 determines the dimensions of the order. These dimensions may have been supplied to scheduler 22 by the retailer 20. At block 76, the scheduler 22 compares the dimensions of the order with the available space within the SLSC 10 for a given time period. The scheduler may keep a running total of space available within the SLSC, Alternately, the computer 68 of FIG. 6 may keep a running total of space available that is supplied, upon automated request, to the scheduler.

If block 76 determines that not enough space is available, control goes to block 78 where the order is divided into two or more portions for separate delivery before returning to block 74.

Once block 76 determines that sufficient space is available, control goes to block 80 where space for the delivery is reserved. Next, block 82 sends an access signal from the scheduler 22 to the SLSC 10 such that a delivery agent may unlock it during a prescribed time interval. Block 84 indicates that the delivery is made, after which block 86 corresponds to the computer 68 of the SLSC 10 sending a delivery made signal to the scheduler. Upon receipt of the signal indicating delivery, the scheduler 22 or another part of the delivery system computer on which the scheduling software runs, sends a charge account signal. The charge account signal debits or charges the customers account for the delivery which had just been made.

As noted above, the method and system of the invention are associated with a non-transitory computer readable medium having stored thereon computer executable instructions that when executed by a processor to perform the operations described herein.

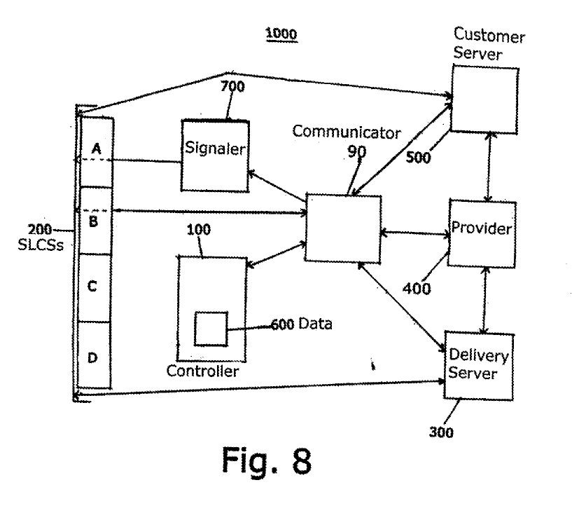

FIG. 8 is a block diagram illustrating a system 10 for managing the delivery of goods ordered from a provider thereof to a SLSC according to the present invention.

As shown in FIG. 8, the system 10 includes a smart communicator 90, controlled by controller 100, for internetworking and communicating with a delivery server 300, a provider of ordered goods 400, and a customer server 500, and a system of SLSCs 200, which may comprise individual SLCSs A-F, in a form of one or more short messages (SMS messages) or electronic mail (e.g., e-mail).

Upon receiving the one or more SMS messages or e-mails containing information on the articles ordered, the controller 100 stores information relating to the ordered articles, the provider, the customer, the SLSC, and delivery agent in a database 600.

The controller 100 preferably incorporates a computer and controls the overall operation of the system 10, including scheduling the delivery of goods, managing the communications via the smart communicator 90 between the delivery server 300, the customer server 500, the provider 400 and the signaler 700. These communications may take the any convenient forms; e.g., wired or wireless communication links.

Signaler 700 sends a signal to the designated SLSC [A-F] allowing access thereinto by the delivery agent, customer, or agent of the customer. The communicator 90 notifies the customer server 500, by transmitting an arrival message thereto when the goods are delivered into the SLSC.

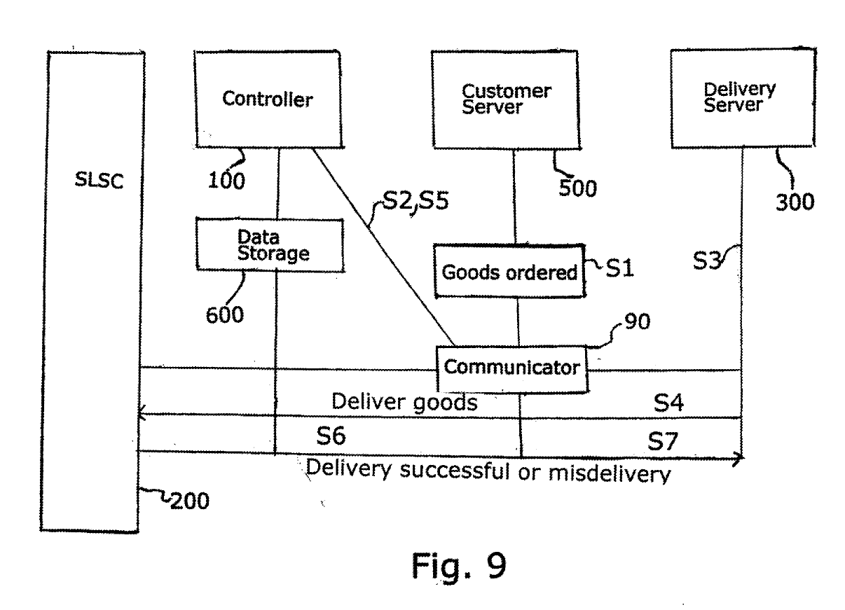

FIG. 9 is a flow diagram illustrating a method for utilizing the system of FIG. 8 to manage deliveries of ordered goods to a SLSC according to the present invention. Referring to FIG. 9, the customer server 500 accesses the provider via communicator 90 to order and pay for goods at step S1. The communicator transmits information regarding the ordered goods to controller 100 at step 82, which schedules delivery of the ordered goods to the customer. Upon completing the scheduling process, the controller sends delivery instructions to the delivery server via smart communicator 80 at step S3. The delivery server provides instructions to the delivery agent (not shown) for delivery of the ordered goods and communicates with signaler 700 (shown in FIG. 8), to allow access to the appropriate SLSC by the delivery agent, and the customer or an agent of the customer.

The ordered goods are then delivered to the SLSC at step S4. Information concerning the goods delivered at step S4 is also conveyed to controller 100 via the smart communicator 90 at step S5. The controller then compares the information received from the delivery server with the original order stored in data storage 600. If the comparison evidences identity between the two pieces of information, the controller forwards to the customer server 500 an indication that the delivery was successful at step S6. If the comparison shows a discrepancy between the ordered goods and the goods delivered, the controller sends a misdelivery message to the customer server 500 at step S7.

It will also be understood by those skilled in the art that the system and method of the invention may also be employed to allow the customer to return misdelivered goods to the provider by simply reversing the above described process.

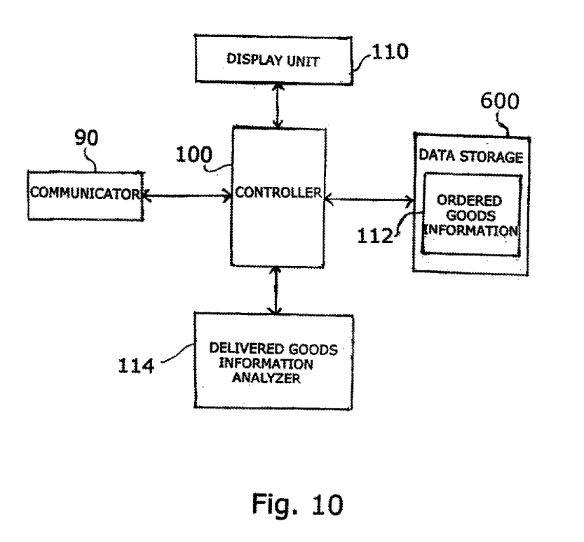

FIG. 10 is a block diagram illustrating the controller in more detail. As shown in FIG. 10, the controller 100 includes a display device 110, smart communicator 90, a data storage 600, an ordered goods information unit 112, and a delivered goods information analyzer 114. The display unit 110, displays the operation status of the various units operated, managed, and controlled by controller 100. The controller also compares the information concerning the ordered good with the information relating to the delivered goods. If the two are in agreement, a message of successful delivery is sent to the customer server 500, as described above. If the two pieces of information are not in accord, a message of misdelivery is forwarded to the customer server 500, again as described above.

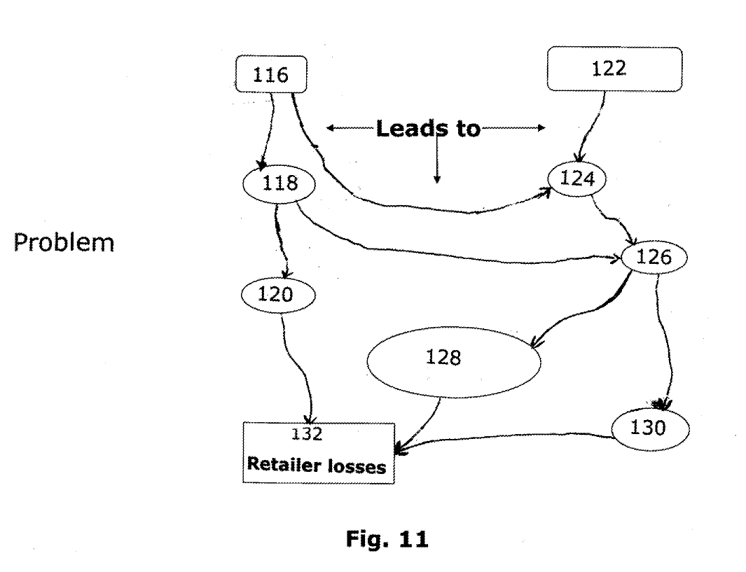

FIG. 11 is a flow diagram that illustrates the problematic disadvantages associated with the models/systems of the prior art. [Each of the arrows ( [symbol] ) depicted in the diagram is an indication of what the numbered disadvantages of the prior art lead to]. Insecure, outdoor, remotely located delivery sites 116 lead to damaged and stolen goods 118, as well as the necessity for costly and inconvenient returns 124 of ordered/purchased goods. The sites 116 typical of the prior art also lead to replacement costs 120 of the damaged or stolen goods 118.

The inconvenient, costly and largely inefficient delivery scheduling and coordination steps required by the prior art lead to costly and inconvenient returns 124 of ordered/purchased goods, which, in turn, leads to consumer inconvenience 126, as well as a disincentive for the purchaser 130 to utilize the seller/provider of goods and a loss of brand loyalty and poor brand experience 128.

The above detailed disadvantages ultimately lead to considerable losses 132 to the seller/provider of the ordered goods.

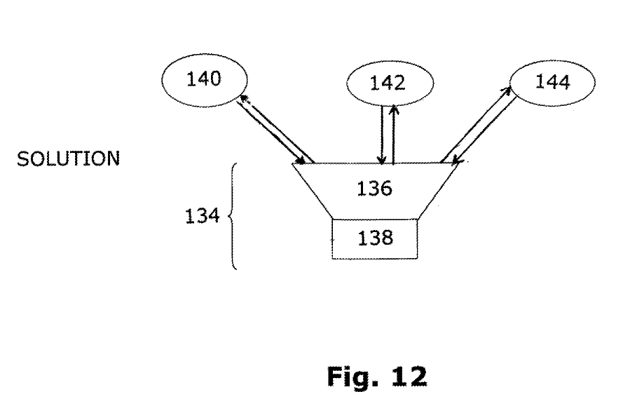

FIG. 12 is a flow diagram that illustrates embodiments of the invention which ameliorate the above described problematic disadvantages associated with the models/systems of the prior art. [Again, each of the arrows ( [symbol] ) depicted in the diagram is an indication of to what the numbered solutions lead].

The centralized base platform/host system 136 which is powered by HomeValet 134 communicates directly with the seller/provider 140 of goods, which are bought/ordered by the consumer 144. The platform, upon completion of the buying/ordering process, immediately communicates with the carrier 142 of the ordered/purchased goods to deliver same to the SLSC 138.

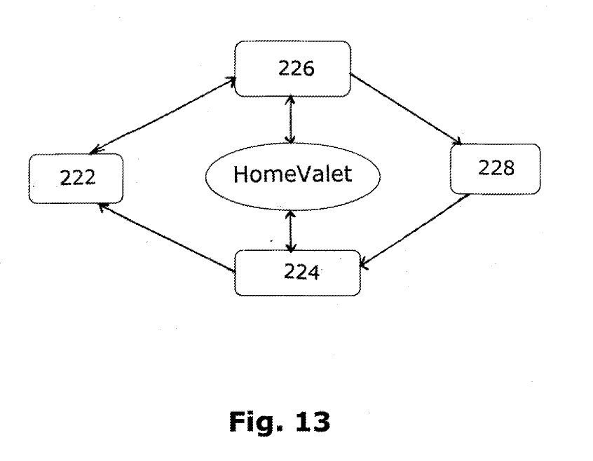

FIG. 13 is a flow diagram that illustrates further embodiments of the invention. [Each of the arrows ( [symbol] ) depicted in the diagram is an indication of to what can be achieved among and between the numbered components].

Depicted are the centralized HomeValet platform System, the consumer/customer 224, the supplier of goods 222, the carrier of the purchased/ordered goods 226 and the SLSC 228.

The supplier of goods 222 provides purchase and delivery information to HomeValet, which provides this information to prospective purchasers/orderers of goods to customer 224, and thereafter monitors and manages deliveries from the carrier 226 through, for example, a mobile app; it being understood by those skilled in the art that any convenient app may be employed to accomplish the goals of the invention. The supplier of goods 222 may also communicate directly with carrier 226 to exchange, for example, delivery information and tracking statuses. HomeValet may also directly communicate with carrier 226 to provide authorization for the delivery and exchange other information required to complete the delivery process. Carrier 226 communicates directly with SLSC 228 for purposes of accessing the latter to deliver the goods and provide information thereto which may be required. The customer 224, upon retrieval of the goods from SLSC 228, may also receive from SLSC 228, further information as to the condition of the container such as, for example, that additional goods are present therein for retrieval or that it is empty. HomeValet may also exchange information with SLSC 228 such as, for example, authorization for access by carrier 226. The latter may also update HomeValet as to the status of the delivery. Customer 224 and supplier 222 may also exchange information such as, for example, loyalty/reward benefits, discounts, auto-refills and the like.

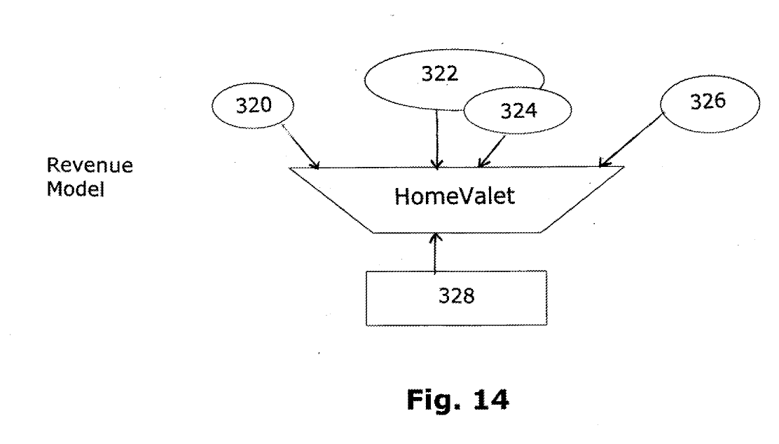

FIG. 14 is a flow diagram that illustrates an exemplary revenue model achievable by an embodiment of the invention. [Each of the arrows ( [symbol] ) depicted in the diagram is an indication of the direction of flow of revenue]. Fees paid by the supplier of ordered/purchased goods 320 and the carrier thereof 322, which may include a per item fee 324 flow to HomeValet. The customer 326 also may pay a subscription fee to HomeValet. Finally, the manufacturer of the SLSC may also pay a license fee to HomeValet.

In its simplest form, the crux of the invention resides in a centralized host platform/system communicably coupled to the above herein described servers via an application programming interface (API) such as a local area network (IAN), wide area network (WAN), the Internet or others.

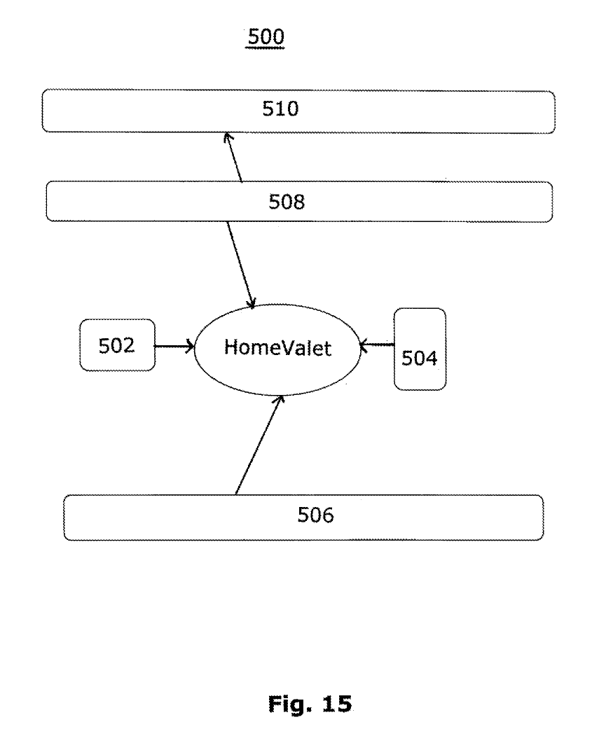

FIG. 15 is a block diagram of the immediately above described system 500, wherein the centralized HomeValet system is in communication with and manages each of the internal platform APIs 502, the SLSC API 506, the customer server 504, which is depicted as a mobile app, but, as will be understood by those skilled in the art may comprise any convenient server and corresponding app/API. HomeValet also communicates with the carrier server API 508 and the supplier of ordered/purchased goods 510.

The foregoing description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

What is claimed is:

1. A system for managing the delivery of goods ordered by a customer from a provider thereof to at least one smart locked storage container (SLSC), each SLSC associated with the customer comprising:
a customer server for ordering and managing the goods to be delivered to the at least one SLSC
a delivery server for managing deliveries of the goods to the at least one SLSC by a delivery agent;
a smart communicator for enabling communications between the provider of goods, the delivery server, a signaler and/or the customer server;
a controller for controlling the communications; and
a signaler communicatively connected to the SLSC for transmitting a signal to the SLSC allowing access thereinto by the delivery agent, the customer, and/or an agent of the customer.

2. The system of claim 1 wherein the managing of delivery of the goods includes scheduling said delivery.

3. The system of claim 1 wherein said controller enables the communicator to transmit any of:
(1) instructions from the provider of goods to the delivery server for delivering the goods to the at least one SLSC;
(2) information concerning delivery of the ordered goods from the delivery server to the provider
(3) information concerning the ordered goods from either or both of the provider of goods or the delivery server to the customer server; and
(4) information or instructions regarding the delivered goads from the customer server to either or both of the provider or the delivery server.

4. The system of claim 3 wherein the controller enables the transmittal of a user interface to each of the provider, delivery server, a signaler and customer server for facilitating the operations of the communicator, controller and/or signaler.

5. The system of claim 1 wherein the communications comprise pricing, availability of goods, inventory of goods, delivery data concerning the goods, instructions to the delivery server to retrieve the delivered goods from the at least one SLSC.

6. The system of claim 1, wherein the controller enables (1) the smart communicator to transmit misdelivery information to the delivery server when the delivered goods are determined to be mis-delivered, (2) the delivery server to request information for re-delivery of the goods and (3) the provider to re-deliver the ordered goods.

7. A computer readable non-transitory recording medium having a program stored thereon which is executable by at least one processor to operate the delivery server, customer server, communicator, controller and/or signaler of claim 1.

8. A method for managing the delivery of goods ordered by a customer from a provider thereof to at least one smart locked storage container (SLSC), each SLSC associated with the customer comprising utilizing:
a customer server for ordering the goods to be delivered to the at least one SLSC;
a delivery server for managing deliveries of the ordered goods to the at least one SLSC by a delivery agent;
a smart communicator for enabling communications between the provider of goods, the delivery server, a signaler and/or the customer server;
a controller for controlling the communications; and
a signaler for transmitting a signal to the SLSC allowing access thereinto by the delivery agent, the customer, and/or an agent of the customer.

9. A computer readable non-transitory recording medium having a program stored thereon which is executable by at least one processor to operate the delivery server, customer server, communicator, controller and/or signaler of claim 8.

10. In a method of delivery of ordered items to a plurality of smart locked storage containers (SLSC), each SLSC being associated with a corresponding customer, using a delivery system including a scheduler, the steps including: ordering a first delivery of one or more goods for a first customer associated with a first SLSC of the plurality thereof; following the ordering of the first delivery, determining the availability of the first SLSC to receive the first delivery at one or more times by use of the scheduler; identifying, using the scheduler, a first time interval during which the first delivery can be made; and the delivery system sending to the first SLSC an access signal allowing a first delivery agent to access the first SLSC only during the first time interval, the improvement wherein the SLSCs are associated with
a customer server for ordering and managing the goods to be delivered to the SLSCs;
a delivery server for managing deliveries of the goods to the SLSCs by a delivery agent;
a smart communicator for enabling communications between the provider of goods, the delivery server, a signaler and/or the customer server;
a controller for controlling the communications; and
a signaler for transmitting a signal to the SLSCs allowing access thereinto by the delivery agent, the customer, and/or an agent of the customer.

11. A computer readable non-transitory recording medium having a program stored thereon which is executable by at least one processor to operate the delivery server, customer server, communicator, controller and/or signaler of claim 10.

12. A system according to claim 1 for further enabling return of the delivered goods from the SLSC to the provider thereof, wherein:
the customer server further manages return of the goods from the at least one SLSC to the provider;
the delivery server further manages return of the goods from the at least one SLSC to the provider thereof by the delivery agent.

13. A computer readable non-transitory recording medium having a program stored thereon which is executable by at least one processor to operate the delivery server, customer server, communicator, controller and/or signaler of claim 12.

14. A method according to claim 7 for further enabling return of the delivered goods from the SLSC to the provider thereof, wherein:
the customer server further manages return of the goods from the at least one SLSC to the provider;
the delivery server further manages return of the goods from the at least one SLSC to the provider thereof by the delivery agent.

15. A computer readable non-transitory recording medium having a program stored thereon which is executable by at least one processor to operate the delivery server, customer server, communicator, controller and/or signaler of claim 14.

16. A delivery system according to claim 9 for further enabling return of the delivered goods from the SLSC to the provider thereof, wherein:
the customer server further manages return of the goods from the at least one SLSC to the provider;
the delivery server further manages return of the goods from the at least one SLSC to the provider thereof by the delivery agent.

17. A computer readable non-transitory recording medium having a program stored thereon which is executable by at least one processor to operate the delivery server, customer server, communicator, controller and/or signaler of claim 16.
